(19) United States
(12) Patent Application Publication
(10) Pub. No.: US 2009/0320217 A1
(43) Pub. Date: Dec. 31, 2009

(54) MIXTURES OF FIBRE-REACTIVE AZO DYES

(75) Inventors: Stefan Ehrenberg, Hattersheim (DE); Stefan Meier, Frankfurt (DE); Christian Schumacher, Kelkheim (DE)

Correspondence Address: CONNOLLY BOVE LODGE & HUTZ, LLP, P O BOX 2207, WILMINGTON, DE, 19899, US

(73) Assignee: DyStar Textifarben GmbH & Co. Deutschland KG, Frankfurt am Main (DE)

(21) Appl. No.: 12/524,929

(22) PCT Filed: Jan. 28, 2008
(86) PCT No.: PCT/EP2008/050917

§ 371 Date: Jul. 29, 2009

(30) Foreign Application Priority Data
Feb. 6, 2007 (DE) 10 2007 005 795.6

(51) Int. Cl. D06P 1/02; C09B 67/36; D06P 5/30

(52) U.S. Cl. 8/466; 8/641; 8/506

(57) ABSTRACT

The present invention provides dye mixtures containing one or more dyes of the general formula (I)

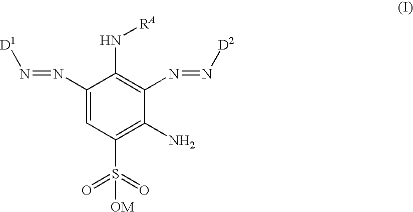

and one or more dyes of the general formulae (II)

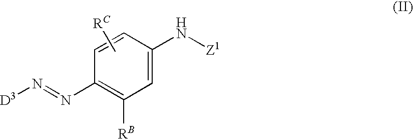

where
D¹, D², D³ R^{A}, R^{B}, R^{C}, Z¹ and M are each as defined in claim 1, processes for their preparation and their use.

This invention relates to the technical field of fiber-reactive azo dyes.

Fiber-reactive azo dye mixtures and their use for dyeing hydroxyl- and carboxamido-containing materials in golden yellow to orange hues are known for example from EP 1 000 982 A2 and CN 1861695. However, they have certain performance defects, for example an insufficient color buildup at low dye concentrations, which ultimately compromises the economics of the dyeing operation.

Consequently, there continues to be a demand for novel reactive dyes or reactive dye mixtures having improved properties, such as steep color buildup coupled with good fastnesses. They shall moreover also provide good dyeing yields and have high reactivity and they shall more particularly provide dyeings having high degrees of fixation.

The present invention, then, provides dye mixtures which have these above-described properties to a high degree. The novel dye mixtures are notable in particular for high yields of fixation and ready washoff for portions not fixed on the fiber. In addition, the dyeings exhibit good general fastnesses, for example high lightfastness and very good wetfastnesses.

The present invention accordingly provides a dye mixture containing one or more dyes of the general formula (I)

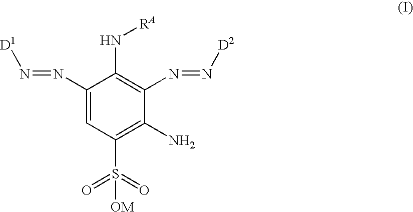

and one or more dyes of the general formulae (II)

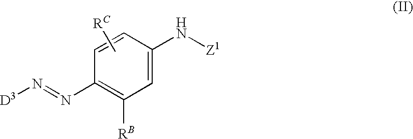

where
D¹, D² and D³ independently represent a group of the general formula (III)

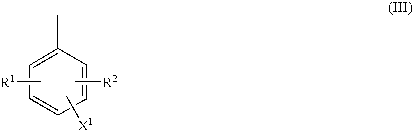

where
R¹ and R² are independently hydrogen, (C₁-C₄)-alkyl, (C₁-C₄)-alkoxy, hydroxyl, sulfo, carboxyl, cyano, nitro, amido, ureido or halogen; and
X¹ is hydrogen, sulfo, a group of the formula —SO₂-Z², where

### Z² is —CH═CH₂ or —CH₂CH₂Z³ and

Z³ is hydroxyl or an alkali-eliminable group;
or is a group of the formula (IV)

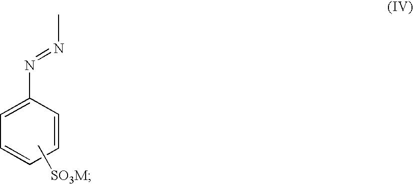

or where
D¹, D² and D³ independently represent a group of the general formula (V)

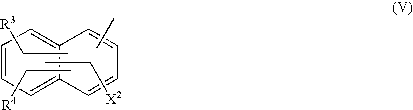

where
R³ and R⁴ are independently hydrogen, (C₁-C₄)-alkyl, (C₁-C₄)-alkoxy, hydroxyl, sulfo, carboxyl, cyano, nitro, amido, ureido or halogen; and
X² has one of the meanings of X¹;
or where
D¹, D² and D³ independently represent a group of the general formula (VI)

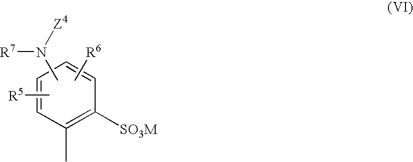

where
R⁵ and R⁶ independently have one of the meanings of R¹;
R⁷ is hydrogen (C₁-C₄)-alkyl, unsubstituted or (C₁-C₄)-alkyl-, (C₁-C₄)-alkoxy-, sulfo-, halogen- or carboxyl-substituted phenyl; and
Z⁴ is a group of the general formula (VII), (VIII) or (IX)

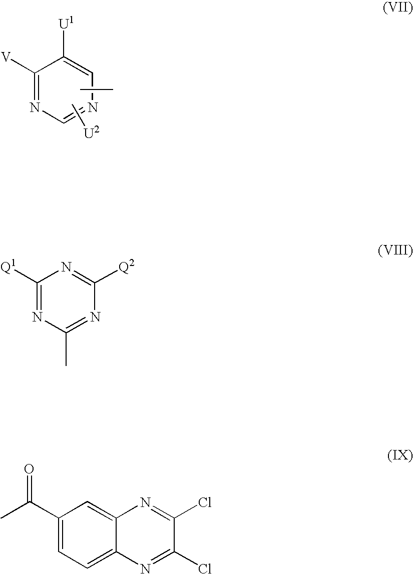

where
V is fluorine or chlorine;
U¹ and U² are independently fluorine, chlorine or hydrogen; and
Q¹ and Q² are independently chlorine, fluorine, cyanamido, hydroxyl, (C₁-C₆)-alkoxy, phenoxy, sulfophenoxy, mercapto, (C₁-C₆)-alkylmercapto, pyridino, carboxypyridino, carbamoylpyridino or a group of the general formula (X) or (XI)

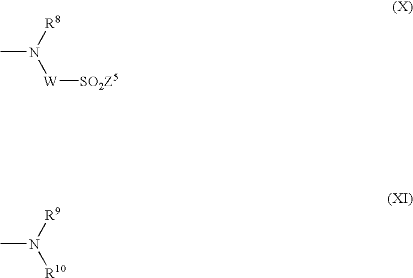

where
R⁸ is hydrogen, (C₁-C₆)-alkyl, sulfo-(C₁-C₆)-alkyl, phenyl or (C₁-C₄)-alkyl-, (C₁-C₄)-alkoxy-, hydroxyl-, sulfo-, halogen-, carboxyl-, acetamido-, ureido-substituted phenyl;
R⁹ and R¹⁰ independently have one of the meanings of R⁸ or combine to form a group of the formula —(CH₂)ⱼ— or of the formula —(CH₂)₂-E-(CH₂)₂—, where j is 4 or 5, E is oxygen, sulfur, sulfonyl or —NR¹¹ and R¹¹ is (C₁-C₆)-alkyl;
W is phenylene which is unsubstituted or substituted by 1 or 2 substituents selected from the group consisting of (C₁-C₄)-alkyl, (C₁-C₄)-alkoxy, carboxyl, sulfo, chlorine and bromine, or is (C₁-C₄)-alkylenephenylene, (C₂-C₆)-alkylene, which may be interrupted by oxygen, sulfur, sulfonyl, amino, carbonyl or carboxamido, or is phenylene CONH phenylene which is unsubstituted or substituted by 1 or 2 substituents selected from the group consisting Of (C₁-C₄)-alkyl, (C₁-C₄)-alkoxy, hydroxyl, sulfo, carboxyl, amido, ureido and halogen, or is naphthylene which is unsubstituted or substituted by one or two sulfo groups; and
Z⁵ has one of the meanings of Z²;
or where
D¹, D² and D³ independently represent a group of the general formula (XII)

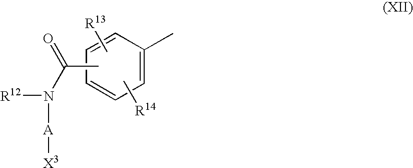

where
R¹² is hydrogen, (C₁-C₄)-alkyl, aryl or substituted aryl;
R¹³ and R¹⁴ are independently hydrogen, (C₁-C₄)-alkyl, (C₁-C₄)-alkoxy, hydroxyl, sulfo, carboxyl, cyano, nitro, amido, ureido or halogen; and
A is a group of the general formula (XIII)

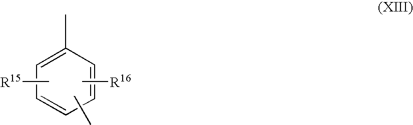

where
R¹⁵ and R¹⁶ are independently hydrogen, (C₁-C₄)-alkyl, (C₁-C₄)-alkoxy, hydroxyl, sulfo, carboxyl, cyano, nitro, amido, ureido or halogen; or
A is a group of the general formula (XIV)

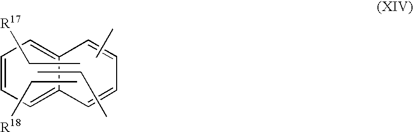

where
R¹⁷ and R¹⁸ are independently hydrogen, (C₁-C₄)-alkyl, (C₁-C₄)-alkoxy, hydroxyl, sulfo, carboxyl, cyano, nitro, amido, ureido or halogen; or
A is a group of the general formula (XV)

—(CR¹⁹R²⁰)ₖ— (XV)

where
k is an integer greater than 1;
R¹⁹ and R²⁰ are independently hydrogen, (C₁-C₄)-alkyl, (C₁-C₄)-alkoxy, hydroxyl, cyano, amido, halogen or aryl; and
X³ has one of the meanings of X¹;
R^{A} is hydrogen or a group of the general formula (XVII)

—CH₂—SO₃M (XVII);

R^{B} is acetamido, ureido, methyl, methoxy or a group of the general formula (XVIII)

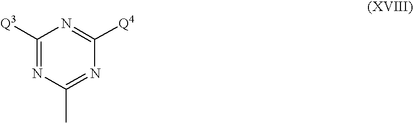

where
Q³ and Q⁴ independently have one of the meanings of Q¹;
R^{C} is hydrogen, methyl, methoxy or sulfo;
Z¹ has one of the meanings of Z⁴; and
M is hydrogen, an alkali metal or one equivalent of an alkaline earth metal;
wherein the dyes of the general formulae (I) and (II) contain at least one fiber-reactive group of the formula —SO₂Z² or Z⁴, of the formula (XVIII) or Z¹ and wherein compounds of the formula (A)

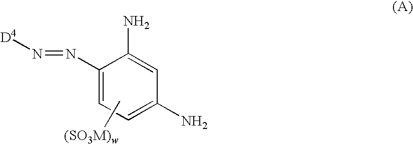

where
D⁴ is a group of the formula (B) or (C)

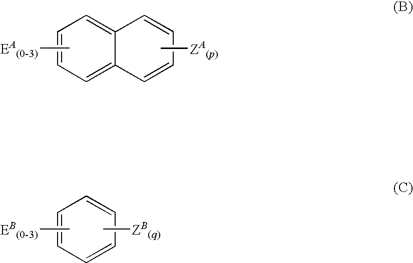

where
E^{A}₍₀₋₃₎ und E^{B}₍₀₋₃₎ are the same or different, 0 to 3 groups selected from hydrogen, —SO₃M, —OH, —COOM, —F, —Cl, —Br, (C₁-C₄)-alkyl oder (C₁-C₄)-alkoxy;
p and q are a number of 0 to 2;
Z^{A} and Z^{B} are a group of formula (Da), (Db), (Dc) or (Dd),

—SO₂—Y^{A} (Da)

—CONH—(CH₂)ᵣ—SO₂—Y^{A} (Db)

—NHCONH(Hal)CH₂Hal (Dc)

—NHCOCH(Hal)=CH₂ (Dd)

r is a number of 0 to 5;
Hal is halogen;
Y^{A} is vinyl, β-chloroethyl, β-bromoethyl, β-acetylethyl, β-sulfatoethyl, β-phen-oxyethyl, β-phosphatoethyl or a —CH₂—CH₂-U group;
U is a leaving group which can be cleaved under alkaline conditions; and
M is defined as given above;
are contained in an amount of maximum 1% by weight, based on the total amount of dyestuff.

(C₁-C₄)-Alkyl groups may be straight chain or branched and are in particular methyl, ethyl, n-propyl, i-propyl, n-butyl, i-butyl, sec-butyl and tert-butyl. Methyl and ethyl are preferred. The same logic applies to (C₁-C₄)-alkoxy groups, which accordingly are preferably methoxy and ethoxy. The same logic also applies to alkylene groups, which are in particular ethylene, propylene and butylene.

Aryl is in particular phenyl or naphthyl, preferably phenyl. Substituted aryl has preferably one, two or three mutually independent substituents selected from the group consisting of (C₁-C₄)-alkyl, (C₁-C₄)-alkoxy, hydroxyl, sulfo, carboxyl, amido and halogen.

Halogen is in particular fluorine, chlorine and bromine, and fluorine and chlorine are preferred.

Alkali M is in particular lithium, sodium or potassium; an alkaline earth metal equivalent M is in particular the equivalent of calcium. M is preferably hydrogen or sodium

Alkali-eliminable Z³ is for example halogen atoms, such as chlorine and bromine, ester groups of organic carboxylic and sulfonic acids, for example alkylcarboxylic acids, substituted or unsubstituted benzenecarboxylic acids and substituted or unsubstituted benzenesulfonic acids, in particular alkanoyloxy of 2 to 5 carbon atoms such as acetyloxy, and also benzoyloxy, sulfobenzoyloxy, phenylsulfonyloxy and toluoylsulfonyloxy, also acidic ester groups of inorganic acids, as of phosphoric acid, sulfuric acid and thiosulfuric acid (phosphate, sulfato and thiosulfato groups), similarly dialkylamino groups having alkyl groups of 1 to 4 carbon atoms each, such as dimethylamino and diethylamino.

Z³ is preferably vinyl, β-chloroethyl and more preferably β-sulfatoethyl.

The groups “sulfo”, “carboxyl”, “thiosulfato”, “phosphate” and “sulfato” include not only their acid form but also their salt form. Accordingly, sulfo groups are groups of the general formula —SO₃M, thiosulfato groups are groups of the general formula —S—SO₃M, carboxyl groups are groups of the general formula —COOM, phosphate groups are groups of the general formula —OPO₃M₂ and sulfato groups are groups of the general formula —OSO₃M, in each of which M is as defined above.

When the dyes of the general formulae (I) and (II) are fiber-reactive groups —SO₂Z² or —SO₂Z⁵, these may partly be present as vinylsulfonyl groups and partly as —CH₂CH₂Z³, preferably as β-sulfatoethylsulfonyl groups. The fraction of the respective dye having a vinylsulfonyl group is in particular up to about 30 mol %, based on the respective total dye.

The radicals R¹ and R² are preferably hydrogen, (C₁-C₄)-alkyl, (C₁-C₄)-alkoxy, sulfo or carboxyl and more preferably hydrogen, methyl, methoxy or sulfo.

The radicals R³ to R⁵ and R¹² to R²⁰ are preferably hydrogen, R³ to R⁶, R¹⁷ and R¹⁸ are also preferably sulfo.

The radicals R⁷ to R¹⁰ are preferably hydrogen or methyl, R⁷ and R⁸ are also preferably phenyl and R⁹ and R¹⁰ are also preferably 2-sulfoethyl, 2-, 3- or 4-sulfophenyl. In addition, R⁹ and R¹⁰ are preferably combined to form —(CH₂)₂—O—(CH₂)₂—.

The radicals R^{A} and R^{C} are preferably hydrogen, while R^{B} is preferably acetamido or ureido.

Preferred dye mixtures of the present invention are accordingly those in which

R¹ and R² are hydrogen, methyl, methoxy or sulfo;
R³ to R⁶ are hydrogen or sulfo;
R⁷ and R⁸ are hydrogen or phenyl;
R⁹ and R¹⁰ are hydrogen, 2-sulfoethyl, 2-, 3- or 4-sulfophenyl or combine to form —(CH₂)₂—O—(CH₂)₂—;
R¹¹ is hydrogen or methyl;
R¹² to R¹⁶, R¹⁹, R²⁰, R^{A} and R^{C} are hydrogen;
R¹⁷ and R^{1a} are hydrogen or sulfo; and
R^{B} is acetamido or ureido.

An X¹—SO₂Z² in the group of the general formula (III) is preferably disposed meta or para to the diazo group.

The bond leading to the diazo group in the group of the general formula (V) is preferably attached to the naphthalene nucleus in the β-position.

Preferred groups of the general formula (III) and (V) are 4-sulfophenyl, 2,4-disulfophenyl, 2,5-disulfophenyl, 4,8-disulfonaphth-2-yl, 6,8-disulfonaphth-2-yl, 1,5-disulfonaphth-2yl, 4,6,8-trisulfonaphth-2-yl, 3,6,8-trisulfonaphth-2-yl, 2-(β-sulfatoethylsulfonyl)phenyl, 2-sulfo-4-(4sulfophenylazo)phenyl, 3-(β-sulfatoethylsulfonyl)phenyl, 4-(β-sulfatoethylsulfonyl)phenyl, 2-carboxy-5-(β-sulfatoethylsulfonyl)phenyl, 2-chloro-4-(β-sulfatoethylsulfonyl)phenyl, 2-chloro-5-(β-sulfatoethylsulfonyl)phenyl, 2-bromo-4-(β-sulfatoethylsulfonyl)phenyl, 2-sulfo-4-(β-sulfatoethylsulfonyl)phenyl, 2-sulfo-5-(β-sulfatoethylsulfonyl)phenyl, 2-methoxy-5-(β-sulfatoethylsulfonyl)phenyl, 2-ethoxy-5-(β-sulfatoethylsulfonyl)phenyl, 2,5-dimethoxy-4-(β-sulfatoethylsulfonyl)-phenyl, 2-methoxy-5-methyl-4-(β-sulfatoethylsulfonyl)phenyl, 2-methyl-4-(β-sulfatoethylsulfonyl)phenyl, 2- or 3- or 4-(β-thiosulfatoethylsulfonyl)phenyl, 2-methoxy-5-(β-thiosulfatoethylsulfonyl)phenyl, 2-sulfo-4-(β-phosphatoethylsulfonyl)phenyl, 2- or 3- or 4-vinylsulfonylphenyl, 2-sulfo-4-vinylsulfonylphenyl, 2-chloro-4-(β-chloroethylsulfonyl)phenyl, 2-chloro-5-(β-chloroethylsulfonyl)phenyl, 3- or 4-(β-acetoxyethyl-sulfonyl)phenyl, 6- or 8-(β-sulfatoethylsulfonyl)naphth-2-yl, 6-(β-sulfatoethylsulfonyl)-1-sulfonaphth-2-yl and 8-(β-sulfatoethylsulfonyl)-6-sulfonaphth-2-yl, preference among which is given to 3-(β-sulfatoethylsulfonyl)phenyl, 4-(β-sulfatoethylsulfonyl)-phenyl, 2-sulfo-4-(β-sulfatoethylsulfonyl)phenyl, 2-methoxy-5-(β-sulfatoethylsulfonyl)-phenyl, 2,5-dimethoxy-4-(β-sulfatoethylsulfonyl)phenyl, 2-methoxy-5-methyl-4-(β-sulfatoethylsulfonyl)phenyl and 3- or 4-vinylsulfonylphenyl.

W in the group of the general formula (X) is preferably 1,3-phenylene, 1,4-phenylene, 2-sulfo-1,4-phenylene, 2-methoxy-1,5-phenylene, 2,5-dimethoxy-1,4-phenylene, 2-methoxy-5-methyl-1,4-phenylene, 1,2-ethylene or 1,3-propylene.

Preferred examples of the groups Q¹ and Q² and respectively Q³ and Q⁴ are independently fluorine, chlorine, hydroxyl, methoxy, ethoxy, phenoxy, 3-sulfophenoxy, 4-sulfophenoxy, methylmercapto, cyanamido, amino, methylamino, ethylamino, morpholino, piperidino, phenylamino, methylphenylamino, 2-sulfophenylamino, 3-sulfophenylamino, 4-sulfophenylamino, 2,4-disulfophenylamino, 2,5-disulfophenylamino, 2-sulfoethylamino, N-methyl-2-sulfoethylamino, pyridino, 3-carboxypyridino, 4-carboxypyridino, 3-carbamoylpyridino, 4-carbamoylpyridino, 2-(2-sulfatoethylsulfonyl)-phenylamino, 3-(2-sulfatoethylsulfonyl)-phenylamino, 4-(2-sulfatoethylsulfonyl)-phenylamino, N-ethyl-3-(2-sulfatoethylsulfonyl)-phenylamino, N-ethyl-4-(2-sulfatoethylsulfonyl)-phenylamino, 2-carboxy-5-(2-sulfatoethylsulfonyl)-phenylamino), 2-chloro-4-(2-sulfatoethylsulfonyl)-phenylamino, 2-chloro-5-(2-sulfatoethylsulfonyl)-phenylamino, 2-bromo-4-(2-sulfatoethylsulfonyl)-phenylamino, 2-sulfo-4-(2-sulfatoethylsulfonyl)-phenylamino, 2-sulfo-5-(2-sulfatoethylsulfonyl)phenylamino, 2-methoxy-5-(2-sulfatoethylsulfonyl)-phenylamino, 2,5-dimethoxy-4-(2-sulfatoethylsulfonyl)-phenylamino, 2-methoxy-5-methyl-4-(2-sulfatoethylsulfonyl)-phenylamino, 2-methyl-4-(2-sulfatoethylsulfonyl)-phenylamino, 2-(vinylsulfonyl)-phenylamino, 3-(vinylsulfonyl)-phenylamino, 4-(vinylsulfonyl)-phenylamino, N-ethyl-3-(vinylsulfonyl)-phenylamino, N-ethyl-4-(vinylsulfonyl)-phenylamino, 6-(2-sulfatoethylsulfonyl)-naphth-2-ylamino, 8-(2-sulfatoethylsulfonyl)-naphth-2-ylamino, 8-(2-sulfatoethylsulfonyl)-6-sulfo-naphth-2-ylamino, 3-(2-(2-sulfatoethylsulfonyl)-ethylcarbamoyl)-phenylamino, 4-(2-(2-sulfatoethylsulfonyl)-ethylcarbamoyl)-phenylamino, 3-(2-(vinylsulfonyl)-ethylcarbamoyl)-phenylamino, 4-(2-(2-vinylsulfonyl)-ethylcarbamoyl)-phenylamino, 4-(N-methyl-2-(2-sulfatoethylsulfonyl)-ethylcarbamoyl)-phenylamino, 4-(N-phenyl-2-(2-sulfatoethylsulfonyl)ethylcarbamoyl)phenylamino, 4-(3-(2-sulfatoethylsulfonyl)-phenylcarbamoyl)-phenylamino, 4-(4-(2-sulfatoethyl-sulfonyl)-phenylcarbamoyl)-phenylamino, 3-(3-(2-sulfatoethylsulfonyl)-phenyl-carbamoyl)-phenylamino, 3-(4-(2-sulfatoethylsulfonyl)-phenylcarbamoyl)-phenylamino, 3-(2-sulfatoethylsulfonyl)-propylamino, N-methyl-N-(2-(2-sulfatoethylsulfonyl)-ethyl)-amino, N-phenyl-N-(2-(2-sulfatoethylsulfonyl)-ethyl)-amino, N-phenyl-N-(2-(2-sulfatoethylsulfonyl)-propyl)-amino and 2-[2-(2-chloroethylsulfonyl)ethoxy]ethylamino. More preferably, Q¹ and Q² are fluorine or chlorine and Q³ and Q⁴ have one of the other meanings mentioned here.

More preferably the groups Q¹ and Q² and respectively Q³ and Q⁴ are independently fluorine, chlorine, cyanamido, morpholino, 2-sulfophenylamino, 3-sulfophenylamino, 4-sulfophenylamino, N-methyl-2-sulfoethylamino, 3-carboxypyridino, 4-carboxypyridino, 3-carbamoylpyridino, 4-carbamoylpyridino, 3-(2-sulfatoethylsulfonyl)-phenylamino, 4-(2-sulfatoethylsulfonyl)-phenylamino, 3-(vinylsulfonyl)-phenylamino, 4-(vinylsulfonyl)-phenylamino, 4-(3-(2-sulfatoethylsulfonyl)-phenylcarbamoyl)-phenylamino, 4-(4-(2-sulfatoethylsulfonyl)-phenylcarbamoyl)-phenylamino, 3-(3-(2-sulfatoethylsulfonyl)-phenylcarbamoyl)-phenylamino, 3-(4-(2-sulfatoethylsulfonyl)-phenylcarbamoyl)-phenylamino, N-methyl-N-(2-(2-sulfatoethylsulfonyl)-ethyl)-amino, N-phenyl-N-(2-(2-sulfatoethylsulfonyl)-ethyl)-amino or 2-[2-(2-chloroethylsulfonyl)-ethoxy]-ethylamino. More particularly, Q¹ and Q² are fluorine or chlorine and Q³ and Q⁴ have one of the other meanings mentioned here.

Most preferably, the groups Q¹ and Q² and respectively Q³ and Q⁴ are independently fluorine, chlorine, cyanamido, morpholino, 2-sulfophenylamino, 3-sulfophenylamino, 4-sulfophenylamino, 3-(2-sulfatoethylsulfonyl)-phenylamino, 4-(2-sulfatoethylsulfonyl)-phenylamino, 3-(vinylsulfonyl)-phenylamino, 4-(vinylsulfonyl)-phenylamino, N-methyl-N-(2-(2-sulfatoethylsulfonyl)-ethyl)-amino, N-phenyl-N-(2-(2-sulfatoethylsulfonyl)-ethyl)-amino or 2-[2-(2-chloroethylsulfonyl)-ethoxy]-ethylamino. More particularly, Q¹ and Q² are fluorine or chlorine and Q³ and Q⁴ have one of the other meanings mentioned here.

Preferably, the groups Z¹ and Z⁴ are 2,4-difluoro-pyrimidin-6-yl, 4,6-difluoro-pyrimidin-2-yl, 5-chloro-2,4-difluoro-pyrimidin-6-yl, 5-chloro-4,6-difluoro-pyrimidin-2-yl, 4,5-difluoro-pyrimidin-6-yl, 5-chloro-4-fluoro-pyrimidin-6-yl, 2,4,5-trichloro-pyrimidin-6-yl 4,5-dichloro-pyrimidin-6-yl, 2,4-dichloro-pyrimidin-6-yl, 4-fluoro-pyrimidin-6-yl, 4-chloro-pyrimidin-6-yl, or a group of the general formula (VIII) having the above-indicated preferred meanings for Q¹ and Q².

More preferably, the groups Z¹ and Z⁴ are 2,4-difluoropyrimidin-6-yl, 4,6-difluoro-pyrimidin-2-yl, 5-chloro-2,4-difluoropyrimidin-6-yl or 5-chloro-4,6-difluoropyrimidin-2-yl or the group of the general formula (VIII) having the above-indicated particularly preferred meanings for Q¹ and Q².

Most preferably, the groups Z¹ and Z² are 2,4-difluoropyrimidin-6-yl or 5-chloro-2,4-difluoropyrimidin-6-yl or the group of the general formula (VIII) having the above-indicated most preferred meanings for Q¹ and Q².

The carboxamide in the group of the general formula (XII) is preferably disposed para or meta to the diazo group. When A is phenylene and X³ is —SO₂Z², the —SO₂Z²- group is preferably disposed meta or para relative to the nitrogen atom. When A is naphthylene, the bond leading to the nitrogen atom is preferably attached to the naphthalene nucleus in the β-position.

Preferred examples of substituents A are 1,2-phenylene, 1,3-phenylene, 1,4-phenylene, 2-chloro-1,4-phenylene, 2-chloro-1,5-phenylene, 2-bromo-1,4-phenylene, 2-sulfo-1,4-phenylene, 2-sulfo-1,5-phenylene, 2-methoxy-1,5-phenylene, 2-ethoxy-1,5-phenylene, 2,5-dimethoxy-1,4-phenylene, 2-methoxy-5-methyl-1,4-phenylene, 2-methyl-1,4-phenylene, 2,6-naphthylene, 2,8-naphthylene, 1-sulfo-2,6-naphthylene, 6-sulfo-2,8-naphthylene or 1,2-ethylene and 1,3-propylene. A is more preferably 1,3-phenylene, 1,4-phenylene, 2-sulfo-1,4-phenylene, 2-methoxy-1,5-phenylene, 2,5-dimethoxy-1,4-phenylene, 2-methoxy-5-methyl-1,4-phenylene or 1,2-ethylene and 1,3-propylene, and in the case of the two last-mentioned alkylene groups R¹² is preferably phenyl or 2-sulfophenyl. When A is a group of the general formula (XV), k is preferably 2 or 3.

D¹ and D² preferably represent a group of the general formula (III) or (VI), the group of the general formula (III) being particularly preferred. In very particularly preferred dye mixtures of the present invention, D¹ and D² have the abovementioned preferred meanings.

D³ preferably represents a group of the general formula (V) and more preferably a group of the general formula (V) where R³, R⁴ and X² are hydrogen or sulfo.

Z¹ is preferably a group of the general formula (VII) where Q¹ and Q² have the abovementioned preferred meanings. More particularly, Q¹ is fluorine or chlorine and Q₂ has one of the other preferred meanings.

More preferably, therefore, Z¹ is a group of the general formula (VIII) where Q¹ is fluorine or chlorine and Q² is cyanamide, morpholino, 2-sulfophenyl-amino, 3-sulfophenylamino, 4-sulfophenylamino, N-methyl-2-sulfoethylamino, 3-carboxypyridino, 4-carboxypyridino, 3-carbamoylpyridino, 4-carbamoylpyridino, 3-(2-sulfatoethylsulfonyl)phenylamino, 4-(2-sulfatoethylsulfonyl)phenylamino, 3-(vinylsulfonyl)phenylamino, 4-(vinylsulfonyl)phenylamino), 4-(3-(2-sulfatoethylsulfonyl)phenylcarbamoyl)-phenylamino, 4-(4-(2-sulfatoethylsulfonyl)phenylcarbamoyl)phenylamino, 3-(3-(2-sulfatoethylsulfonyl)phenylcarbamoyl)phenylamino, 3-(4-(2-sulfatoethylsulfonyl)-phenylcarbamoyl)phenylamino, N-methyl-N-(2-(2-sulfatoethylsulfonyl)-ethyl)amino, N-phenyl-N-(2-(2-sulfatoethylsulfonyl)ethyl)amino, or 2-[2-(2-chloroethylsulfonyl)ethoxy]ethylamino.

Most preferably, therefore, Z¹ is a group of the general formula (VIII) where Q¹ is fluorine or chlorine and Q² is cyanamide, morpholino, 2-sulfophenylamino, 3-sulfophenylamino, 4-sulfophenylamino, 3-(2-sulfatoethylsulfonyl)phenylamino, 4-(2-sulfatoethylsulfonyl)phenylamino, 3-(vinylsulfonyl)phenylamino, 4-(vinylsulfonyl)phenylamino), N-methyl-N-(2-(2-sulfatoethylsulfonyl)ethyl)amino, N-phenyl-N-(2-(2-sulfatoethylsulfonyl)ethyl)amino, or 2-[2-(2-chloroethylsulfonyl)-ethoxy]ethylamino.

Particularly preferred dye mixtures of the present invention contain one or more dyes of the general formula (Ia)

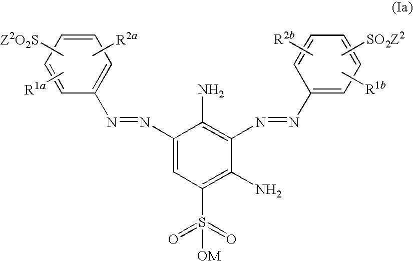

and one or more dyes of the general formula (IIa)

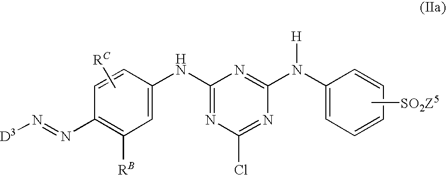

R^{1a}, R^{1b}, R^{2a} and R^{2b} are independently hydrogen, methyl, methoxy or sulfo;
Z² and Z₅ are independently vinyl or β-sulfatoethyl;
and D³, R^{B}, R^{C} and M are as defined above.

The dye mixtures of the present invention contain the dye or dyes of the general formula (I) in an amount of 1% to 99% by weight, preferably 10% to 90% by weight, and the dye or dyes of the general formula (II) in an amount of 1% to 99% by weight, preferably 10% to 90% by weight, all based on total dye.

Preferred dye mixtures of the present invention contain compounds of the formula (A) in an amount of maximum 0.5% by weight, based on the total amount of dyestuff, whereas especially preferred dye mixtures of the present invention contain no compounds of the formula (A).

The dyes according to the invention can be present as a preparation in solid or liquid (dissolved) form. In solid form, they contain, in general, the electrolyte salts customary in the case of water-soluble and especially fiber-reactive dyes, such as sodium chloride, potassium chloride and sodium sulfate, and may further contain the auxiliaries customary in commercial dyes, such as buffer substances capable of setting a pH in aqueous solution between 3 and 7, for example sodium acetate, sodium borate, sodium bicarbonate, sodium dihydrogenphosphate, sodium tricitrate and disodium hydrogenphosphate, and small amounts of siccatives or when they are present in a liquid, aqueous solution (including a content of thickeners of the type customary in print pastes), they may also contain substances which ensure a long life for these preparations, for example mold preventatives.

In solid form, the dye mixtures according to the invention are generally present as powders or granules which contain electrolyte salt and which will hereinbelow generally be referred to as a preparation with or without one or more of the abovementioned auxiliaries. In the preparations, the dye mixture is present at 20 to 90% by weight, based on the preparation containing it. The buffer substances are generally present in a total amount of up to 5% by weight, based on the preparation.

When the dye mixtures according to the invention are present in an aqueous solution, the total dye content of these solutions is up to about 50% by weight, for example between 5 and 50% by weight, the electrolyte salt content preferably being below 10% by weight, based on the aqueous solution. The aqueous solutions (liquid preparations) can also contain buffer substances in an amount which is generally up to 5% by weight and preferably from 0.1 to 2% by weight.

The dye mixtures according to the invention are preparable in a conventional manner, for example by mechanically mixing the individual dyes, whether in the form of their dye powders or granules or in the form of aqueous solutions, for example their as-synthesized solutions, which may additionally contain customary auxiliaries.

As an alternative, suitable mixtures of diazo and coupling components in the desired amount ratios can be obtained by conventional diazotization and coupling reactions.

Dye mixtures which as well as R-chloroethylsulfonyl or β-thiosulfatoethylsulfonyl or β-sulfatoethylsulfonyl groups also contain vinylsulfonyl groups as reactive radicals can be synthesized not only starting from appropriately substituted vinylsulfonyl-anilines or naphthylamines but also by reaction of a dye mixture where Z³ is β-chloroethyl, β-thiosulfatoethyl or β-sulfatoethyl with an amount of alkali required for the desired fraction and converting the β-substituted ethylsulfonyl groups mentioned into vinylsulfonyl groups. This conversion is effected in a manner familiar to one skilled in the art.

The dyes of the general formula (I) are known and are described in EP 0 785 237 A1. Dyes of the general formula (II) are similarly known and are extensively described in the literature. Dyes of the general formula (I) and dyes of the general formula (II) are obtainable via standard methods of synthesis known to one skilled in the art.

The dye mixtures of the present invention have useful application properties and can be used for dyeing and printing carboxamido- and/or hydroxyl-containing materials. The materials mentioned can be for example in the form of sheetlike structures such as paper and leather, in the form of films, for example polyamide films or in the form of a bulk composition, for example polyamide or polyurethane. But particularly they are present in the form of fibers of the materials mentioned. The dye mixtures of the present invention are used for dyeing and printing cellulosic fibrous materials of any kind. They are preferably also useful for dyeing or printing polyamide fibers or blend fabrics composed of polyamide with cotton or with polyester fibers. It is also possible to use the dye mixtures of the present invention to print textiles, paper or other materials by the inkjet process.

The present invention thus also provides for the use of the dye mixtures of the present invention for dyeing printing these materials, or rather processes for dyeing or printing such materials in a conventional manner, by using a dye mixture of the present invention as a colorant. The dye mixtures of the present invention provide orange to red dyeings having very good fastness properties on these materials, preferably fiber materials.

Advantageously, the as-synthesized solutions of the dye mixtures of the present invention can be used directly as a liquid preparation for dyeing, if appropriate after addition of a buffer substance and if appropriate after concentration or dilution.

Fiber materials and fibers herein are in particular textile fibers which can be present as woven fabrics, yarns or in the form of hanks or wound packages.

Carboxamido-containing materials are for example synthetic and natural polyamides and polyurethanes, in particular in the form of fibers, for example wool and other animal hairs, silk, leather, nylon-6,6, nylon-6, nylon-11 and nylon-4.

Hydroxyl-containing materials are those of natural or synthetic origin, for example cellulose fiber materials or their regenerated products and polyvinyl alcohols. Cellulose fiber materials are preferably cotton, but also other vegetable fibers, such as linen, hemp, jute and ramie fibers. Regenerated cellulose fibers are for example staple viscose and filament viscose.

The dye mixtures of the present invention can be applied to and fixed on the materials mentioned, in particular on the fiber materials mentioned, by the application techniques known for water-soluble dyes and particularly for fiber-reactive dyes.

On cellulose fibers, they produce by the exhaust method from a short liquor as well from a long liquor, by using various acid-binding agents and if appropriate neutral salts, such as sodium chloride or sodium sulfate, dyeings having very good color yields. Dyeing is preferably effected by the exhaust method at a pH of 3 to 7 and in particular at a pH of 4 to 6. The liquor ratio can be selected within a wide range and is for example between 3:1 and 100:1 and preferably between 5:1 and 30:1. Applications are preferably from an aqueous bath at temperatures between 40 and 105° C., if appropriate at a temperature of up to 130° C. under superatmospheric pressure, and if appropriate in the presence of customary dyeing auxiliaries. To enhance the wetfastnesses of the dyed material, unfixed dye can be removed in an aftertreatment. This aftertreatment is effected in particular at a pH of 8 to 9 and temperatures of 75 to 80° C.

One possible procedure here is to introduce the material into the warm bath and to gradually heat the bath to the desired temperature and complete the dyeing operation. The neutral salts which accelerate the exhaustion of the dyes can also if desired only be added to the bath after the actual dyeing temperature has been reached.

Padding processes likewise provide excellent color yields and a very good color buildup on cellulose fibers, the dyes being fixable in a conventional manner by batching at room temperature or elevated temperature, for example at up to about 60° C., or by steaming or by means of dry heat.

Similarly, the customary printing processes for cellulose fibers, which can be carried out in one step, for example by printing with a print paste containing sodium bicarbonate or some other acid-binding agent and by subsequent steaming at 100 to 103° C., or in two steps, for example by printing with a neutral to weak acidic print color and then fixing either by passing the printed material through a hot electrolyte-containing alkaline bath or by overpadding with an alkaline electrolyte-containing padding liquor and subsequent batching or steaming or dry heat treatment of the alkali-overpadded material, produce strong color prints with well-defined contours and a clear white ground. The outcome of the prints is affected little, if at all, by variations in the fixing conditions.

When fixing by means of dry heat in accordance with the customary thermofix processes, hot air at 120 to 200° C. is used. In addition to the customary steam at 101 to 103° C., it is also possible to use superheated steam and high-pressure steam at temperatures of up to 160° C.

The acid-binding agents which effect the fixation of the dyes on the cellulose fibers are for example water-soluble basic salts of alkali metals and likewise alkaline earth metals of inorganic or organic acids or compounds which liberate alkali in the heat. Especially suitable are the alkali metal hydroxides and alkali metal salts of weak to medium inorganic or organic acids, the preferred alkali metal compounds being the sodium and potassium compounds. Such acid-binding agents are for example sodium hydroxide, potassium hydroxide, sodium carbonate, sodium bicarbonate, potassium carbonate, sodium formate, sodium dihydrogenphosphate, disodium hydrogenphosphate, sodium trichloroacetate, waterglass or trisodium phosphate.

The dye mixtures of the present invention are notable for outstanding color strength and a steep course of the buildup curve on cellulose fiber materials when applied in the familiar dyeing and printing processes. The dyeings and prints obtainable with the dye mixtures of the present invention on cellulose fiber materials further have good lightfastness and, in particular, good wetfastnesses, such as fastness to washing, milling, water, seawater, crossdyeing and acidic and alkaline perspiration, also good fastness to pleating, hotpressing and rubbing.

The dyeings and prints obtained following the customary aftertreatment of rinsing to remove unfixed dye portions further exhibit excellent wetfastnesses, in particular since unfixed dye portions are easily washed off because of their good solubility in cold water.

Furthermore, the dye mixtures according to the invention can also be used for the fiber-reactive dyeing of wool. Moreover, wool which has been given a nonfelting or low-felting finish (cf. for example H. Rath, Lehrbuch der Textilchemie, Springer-Verlag, 3rd edition (1972), pages 295-299, especially finished by the Hercoseft process (page 298); J. Soc. Dyers and Colourists 1972, 93-99, and 1975, 33-44), can be dyed to very good fastness properties. The process of dyeing on wool is here carried out in a conventional manner from an acidic medium. For instance, acetic acid and/or ammonium sulfate or acetic acid and ammonium acetate or sodium acetate can be added to the dyebath to obtain the desired pH. To obtain a dyeing of acceptable levelness, it is advisable to add a customary leveling agent, for example a leveling agent based on a reaction product of cyanuric chloride with three times the molar amount of an aminobenzenesulfonic acid and/or of an aminonaphthalene-sulfonic acid or on the basis of a reaction product of for example stearylamine with ethylene oxide. For instance, the dye mixture according to the invention is preferably subjected to the exhaust process initially from an acidic dyebath having a pH of about 3.5 to 5.5 under pH control and the pH is then, toward the end of the dyeing time, shifted into the neutral and optionally weakly alkaline range up to a pH of 8.5 to bring about, especially for very deep dyeings, the full reactive bond between the dyes of the dye mixtures according to the invention and the fiber. At the same time, the dye portion not reactively bound is removed.

The procedure described herein also applies to the production of dyeings on fiber materials composed of other natural polyamides or of synthetic polyamides and polyurethanes. These materials can be dyed using the customary dyeing and printing processes described in the literature and known to one skilled in the art (see for example H.-K. Rouette, Handbuch der Textilveredlung, Deutscher Fachverlag GmbH, Frankfurt/Main). In general, the material to be dyed is introduced into the bath at a temperature of about 40° C., agitated therein for some time, the dyebath is then adjusted to the desired weakly acidic, preferably weakly acetic acid, pH and the actual dyeing is carried out at a temperature between 60 and 98° C. However, the dyeings can also be carried out at the boil or in sealed dyeing apparatus at temperatures of up to 106° C. Since the water solubility of the dye mixtures according to the invention is very good, they can also be used with advantage in customary continuous dyeing processes. The color strength of the dye mixtures according to the invention is very high.

The present invention also provides inks for digital textile printing by the inkjet process, containing a dye mixture of the present invention.

The inks of the present invention contain a dye mixture of the present invention for example in amounts of 0.1% to 50% by weight, preferably in amounts of 1% to 30% by weight and more preferably in amounts of 1% to 15% by weight, based on the total weight of the ink. It will be appreciated that the inks can also contain mixtures of dye mixtures of the present invention and other dyes used in textile printing. For the inks to be used in the continuous flow process, a conductivity of 0.5 to 25 mS/m can be set by adding an electrolyte. Useful electrolytes include for example lithium nitrate and potassium nitrate.

The inks of the present invention can contain organic solvents in a total amount of 1-50% and preferably 5-30% by weight.

Suitable organic solvents are for example alcohols, for example methanol, ethanol, 1-propanol, isopropanol, 1-butanol, tert-butanol, pentyl alcohol, polyhydric alcohols for example: 1,2-ethanediol, 1,2,3-propanetriol, butanediol, 1,3-butanediol, 1,4-butanediol, 1,2-propanediol, 2,3-propanediol, pentanediol, 1,4-pentanediol, 1,5-pentanediol, hexanediol, D,L-1,2-hexanediol, 1,6-hexanediol, 1,2,6-hexanetriol, 1,2-octanediol, polyalkylene glycols, for example: polyethylene glycol, polypropylene glycol, alkylene glycols having 2 to 8 alkylene groups, for example monoethylene glycol, diethylene glycol, triethylene glycol, tetraethylene glycol, thioglycol, thiodiglycol, butyltriglycol, hexylene glycol, propylene glycol, dipropylene glycol, tripropylene glycol, low alkyl ethers of polyhydric alcohols, for example: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether, tripropylene glycol isopropyl ether, polyalkylene glycol ethers, such as for example: polyethylene glycol monomethyl ether, polypropylene glycol glycerol ether, polyethylene glycol tridecyl ether, polyethylene glycol nonylphenyl ether, amines, such as, for example: methylamine, ethylamine, triethylamine, diethylamine, dimethylamine, trimethylamine, dibutylamine, diethanolamine, triethanolamine, N-formylethanolamine, ethylenediamine,

urea derivatives, such as for example: urea, thiourea, N-methylurea, N,N′-epsilon-dimethylurea, ethyleneurea, 1,1,3,3-tetramethylurea, N-acetylethanolamine, amides, such as for example: dimethylformamide, dimethylacetamide, acetamide, ketones or keto alcohols, such as for example: acetone, diacetone alcohol, cyclic ethers, such as for example: tetrahydrofuran, trimethylolethane, trimethylolpropane, 2-butoxyethanol, benzyl alcohol, 2-butoxyethanol, gamma butyrolactone, epsilon-caprolactam,
further sulfolane, dimethylsulfolane, methylsulfolane, 2,4-dimethylsulfolane, dimethyl sulfone, butadiene sulfone, dimethyl sulfoxide, dibutyl sulfoxide, N-cyclohexyl-pyrrolidone, N-methyl-2-pyrrolidone, N-ethylpyrrolidone, 2-pyrrolidone, 1-(2-hydroxyethyl)-2-pyrrolidone, 1-(3-hydroxypropyl)-2-pyrrolidone, 1,3-dimethyl-2-imidazolidinone, 1,3-dimethyl-2-imidazolinone, 1,3-bismethoxymethylimidazolidine, 2-(2-methoxyethoxy)ethanol, 2-(2-ethoxyethoxy)ethanol, 2-(2-butoxyethoxy)ethanol, 2-(2-propoxyethoxy)ethanol, pyridine, piperidine, butyrolactone, trimethylpropane, 1,2-dimethoxypropane, dioxane, ethyl acetate, ethylenediaminetetraacetate, ethyl pentyl ether, 1,2-dimethoxypropane and trimethylpropane.

The inks of the present invention may further contain customary additives, for example viscosity moderators to set viscosities in the range from 1.5 to 40.0 mPas in a temperature range from 20 to 50° C. Preferred inks have a viscosity of 1.5 to 20 mPas and particularly preferred inks have a viscosity of 1.5 to 15 mPas. Useful viscosity moderators include rheological additives, for example: polyvinylcaprolactam, polyvinylpyrrolidone and their copolymers polyetherpolyol, associative thickeners, polyurea, polyurethane, sodium alginates, modified galactomannans, polyetherurea, polyurethane, nonionic cellulose ethers.

As further additives the inks of the invention may include surface-active substances to set surface tensions of 20 to 65 mN/m, which are adapted if necessary as a function of the process used (thermal or piezotechnology).

Useful surface-active substances include for example: all surfactants, preferably nonionic surfactants, butyldiglycol, 1,2-hexanediol.

The inks may further include customary additives, for example substances to inhibit fungal and bacterial growth in amounts from 0.01 to 1% by weight based on the total weight of the ink.

The inks of the invention may be prepared in a conventional manner by mixing the components in water.

The inks of the invention are useful in inkjet printing processes for printing a wide variety of pretreated materials, such as silk, leather, wool, cellulosic fiber materials of any kind and polyurethanes, and especially polyamide fibers. The printing inks of the invention are also useful for printing pretreated hydroxyl- or amino-containing fibers present in blend fabrics, for example blends of cotton, silk, wool with polyester fibers or polyamide fibers.

In contrast to conventional textile printing, where the printing ink already contains all the fixing chemicals and thickeners for a reactive dye, in inkjet printing the auxiliaries have to be applied to the textile substrate in a separate pretreatment step. The pretreatment of the textile substrate, for example cellulose and regenerated cellulose fibers and also silk and wool, is effected with an aqueous alkaline liquor prior to printing. To fix reactive dyes there is a need for alkali, for example sodium carbonate, sodium bicarbonate, sodium acetate, trisodium phosphate, sodium silicate, sodium hydroxide, alkali donors such as, for example, sodium chloroacetate, sodium formate, hydrotropic substances such as, for example, urea, reduction inhibitors, for example sodium nitrobenzenesulfonates, and also thickeners to prevent flowing of the motives when the printing ink is applied, for example sodium alginates, modified polyacrylates or highly etherified galactomannans. These pretreatment reagents are uniformly applied to the textile substrate in a defined amount using suitable applicators, for example using a 2- or 3-roll pad, contactless spraying technologies, by means of foam application or using appropriately adapted inkjet technologies, and subsequently dried. After printing, the textile fiber material is dried at 120 to 150° C. and subsequently fixed.

The fixing of the inkjet prints prepared with reactive dyes may be effected at room temperature or with saturated steam, with superheated steam, with hot air, with microwaves, with infrared radiation, with laser or electron beams or with other suitable energy transfer techniques.

A distinction is made between one- and two-phase fixing processes. In one-phase fixing, the necessary fixing chemicals are already on the textile substrate.

In two-phase fixing, this pretreatment is unnecessary. Fixing only requires alkali, which, following inkjet printing, is applied prior to the fixing process, without intermediate drying. There is no need for further additives such as urea or thickener. Fixing is followed by the print aftertreatment, which is the prerequisite for good fastnesses, high brilliance and an impeccable white ground.

The prints produced using the inks of the present invention have, in particular on polyamide, a high color strength and a high fiber-dye bond stability not only in the acidic region but also in the alkali region, also good lightfastness and very good wetfastness properties, such as fastness to washing, water, seawater, crossdyeing and perspiration, and also good fastness to pleating, hotpressing and rubbing.

The examples hereinbelow serve to illustrate the invention. Parts and percentages are by weight, unless otherwise stated. Parts by weight relate to parts by volume as the kilogram relative to the liter. The compounds described in the examples in terms of a formula are indicated in the form of the sodium salts, since they are generally prepared and isolated in the form of their salts, preferably sodium or potassium salts, and used for dyeing in the form of their salts. The starting compounds described in the examples hereinbelow, especially the table examples, can be used in the synthesis in the form of the free acid or likewise in the form of their salts, preferably alkali metal salts, such as sodium or potassium salts.

### EXAMPLE 1

20 parts of an electrolyte-containing dye powder containing the orange dye of the formula (Ib)

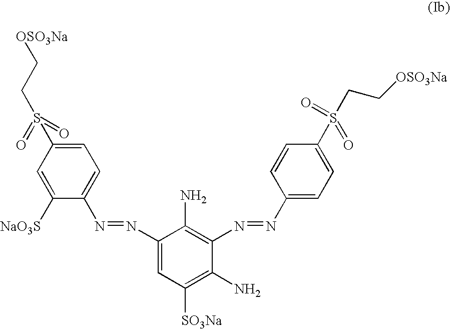

in a 75% fraction and 80 parts of an electrolyte-containing dye powder containing the yellow dye of the formula (IIb)

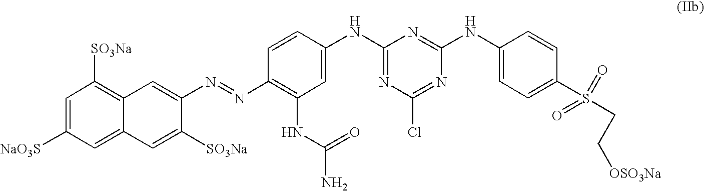

in a 75% fraction, are dissolved in 500 parts of water and the resulting dye solution is adjusted to pH 5.5-6.5. Evaporating this dye solution gives a dye mixture providing yellow to golden yellow dyeings and prints on cotton under the dyeing conditions customary for reactive dyes.

Alternatively, the dye solution obtained can also be buffered at pH 5.5-6 by addition of a phosphate buffer and be further diluted or concentrated to provide a liquid brand of defined strength.

### EXAMPLE 2

20 parts of an electrolyte-containing dye powder containing the orange dye of the formula (Ib) in a 70% fraction and 80 parts of an electrolyte-containing dye powder containing the golden yellow dye of the formula (IIc)

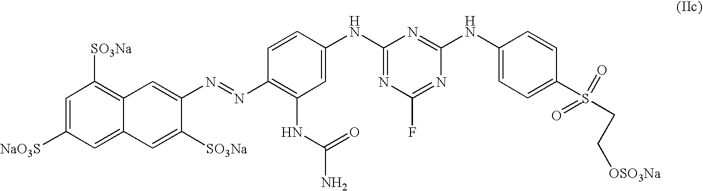

in a 70% fraction are mechanically mixed with each other.

The resulting dye mixture in accordance with the present invention provides yellow dyeings and prints on cotton for example under the dyeing conditions customary for reactive dyes.

### EXAMPLE 3

20 parts of an electrolyte-containing dye powder containing the orange disazo dye of the formula (I-1) in a 75% fraction and 80 parts of an electrolyte-containing dye powder containing the yellow azo dye of the formula (IId)

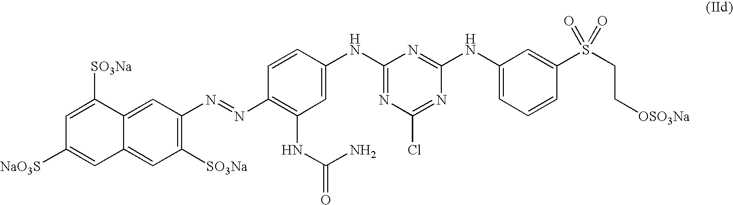

in a 65% fraction, are dissolved in 500 parts of water and the resulting dye solution is adjusted to pH 5.5-6.5. Evaporating this dye solution gives a dye mixture providing yellow dyeings and prints on cotton under the dyeing conditions customary for reactive dyes.

Alternatively, the dye solution obtained can also be buffered at pH 5.5-6 by addition of a phosphate buffer and be further diluted or concentrated to provide a liquid brand of defined strength.

### EXAMPLES 4 TO 22

The examples which follow describe further inventive dye mixtures in each of which the dyes of the general formulae (I) and (II) are each listed in the form of the sodium salts and are obtainable by the processes described in examples 1 to 3. The mixing ratios are reported in percent by weight. The dye mixtures provide yellow to yellowish orange dyeings on cotton for example by the dyeing methods customary for reactive dyes.

| Example | Dye of general formula (I) |
|---|---|
| 4 | (Ib) |
| 5 | 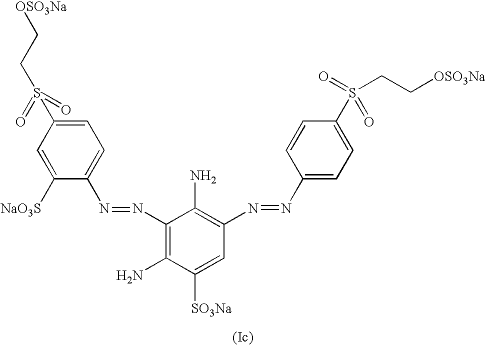 |
| 6 | (Ib) |
| 7 | (Ic) |
| 8 | 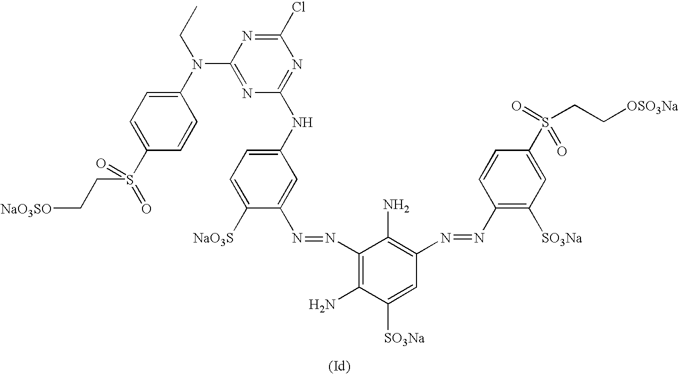 |
| 9 | 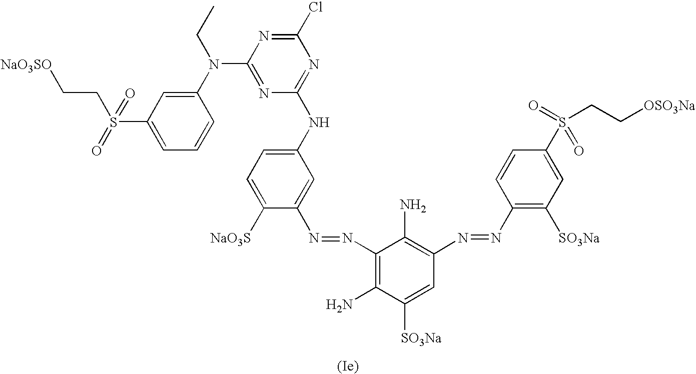 |
| 10 | (Ie) |
| 11 | 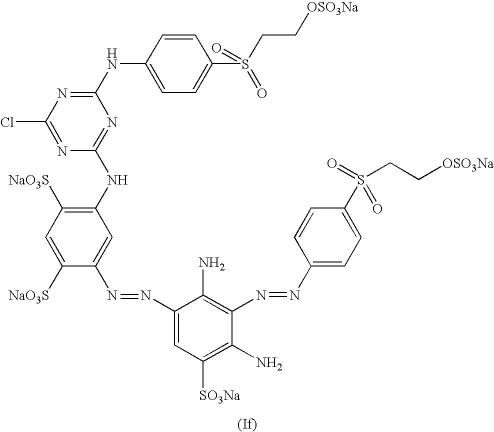 |
| 12 | 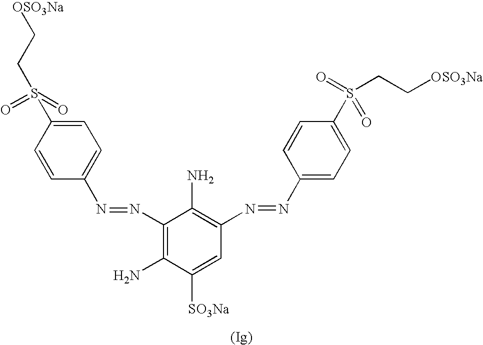 |
| 13 | 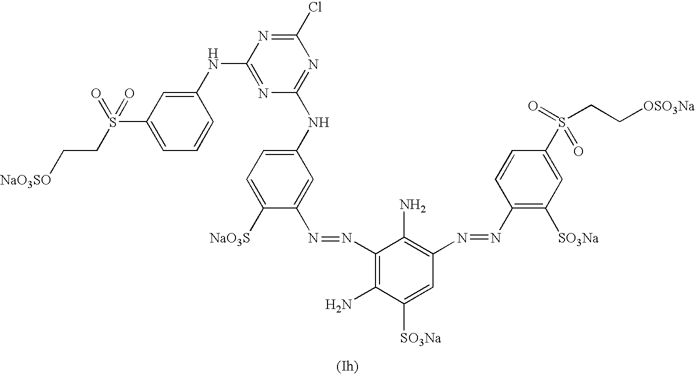 |
| 14 | 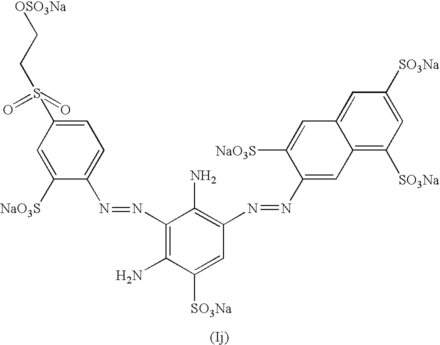 |
| 15 | 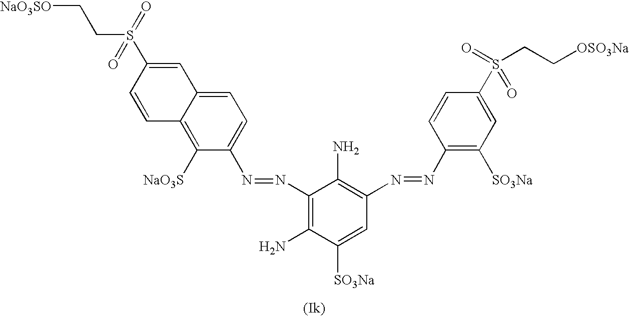 |
| 16 | (Ib) |
| 17 | (Ib) |
| 18 | (Ib) |
| 19 | 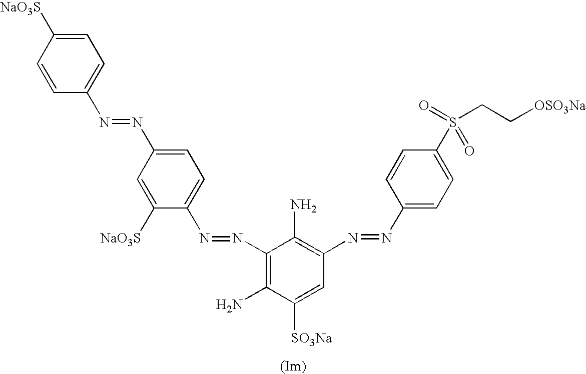 |
| 20 | (Ib) |
| 21 | (Ic) |
| 22 | (Ib) |

| | | Ratio |
|---|---|---|
| Example | Dye of general formula (II) | (I):(II) |
| 4 | 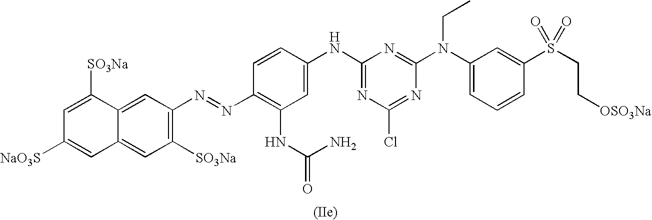 | 70:30 |
| 5 | 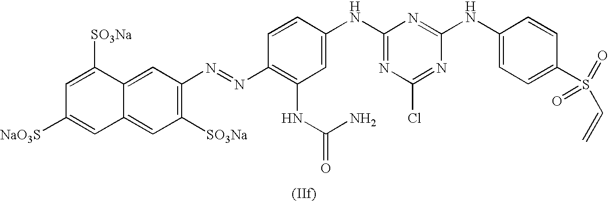 | 75:25 |
| 6 | 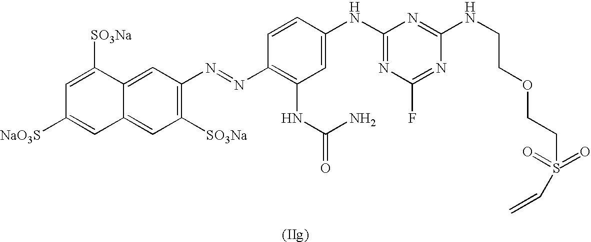 | 60:40 |
| 7 | 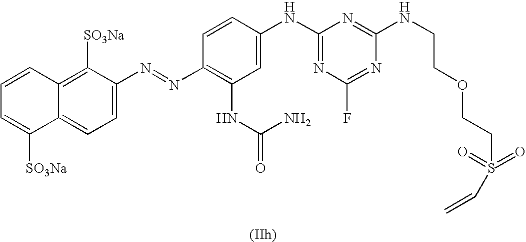 | 50:50 |
| 8 | 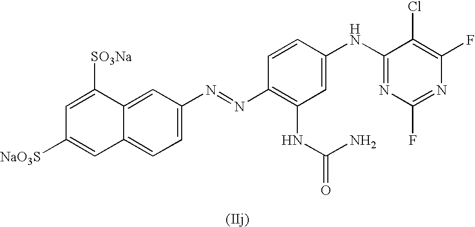 | 80:20 |
| 9 | 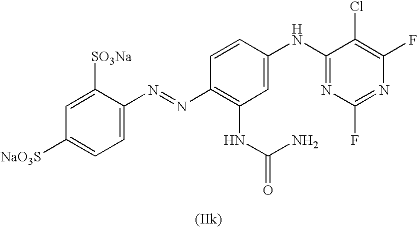 | 67:33 |
| 10 | 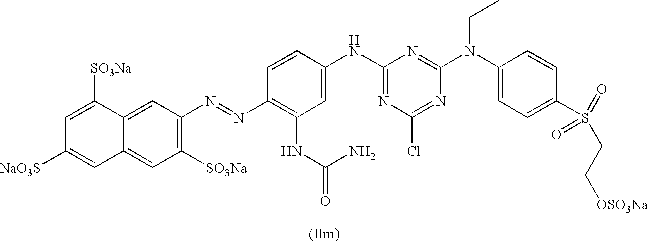 | 40:60 |
| 11 | 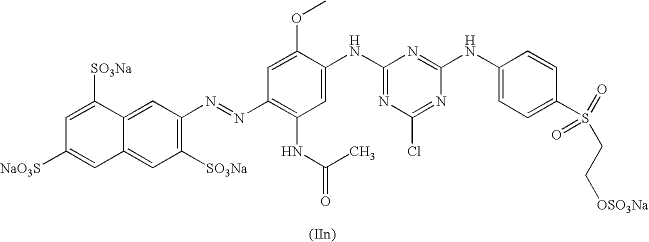 | 85:15 |
| 12 | (IIf) | 35:65 |
| 13 | (IIj) | 90:10 |
| 14 | (IIk) | 83:17 |
| 15 | 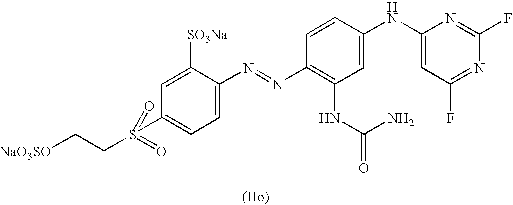 | 80:20 |
| 16 | 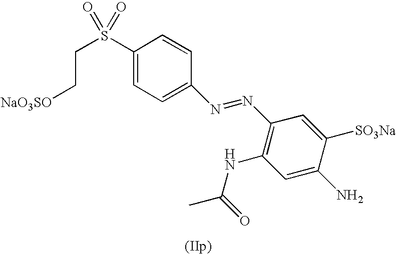 | 60:40 |
| 17 | 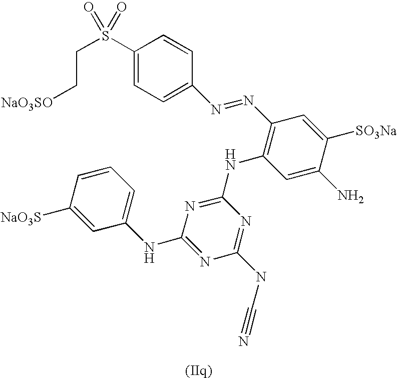 | 20:80 |
| 18 | (IIo) | 75:25 |
| 19 | (IIp) | 50:50 |
| 20 | 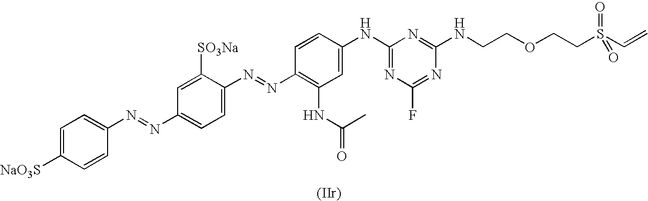 | 60:40 |
| 21 | (IIo) | 23:77 |
| 22 | 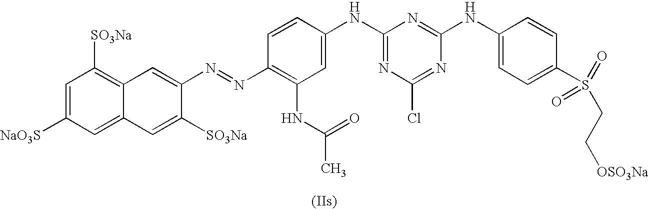 | 18:82 |

### EXAMPLE 23

2 parts of a dye mixture obtained as per example 1 and 50 parts of sodium chloride are dissolved in 999 parts of water and 5 parts of sodium carbonate, 0.7 part of sodium hydroxide (in the form of a 32.5% aqueous solution) and, if appropriate, 1 part of a wetting agent are added. This dyebath is entered with 100 g of a woven cotton fabric. The temperature of the dyebath is initially maintained at 25° C. for 10 minutes, then raised to the final temperature (40-80° C.) over 30 minutes and maintained at the final temperature for a further 60-90 minutes. Thereafter, the dyed fabric is initially rinsed with tap water for 2 minutes and then with deionized water for 5 minutes. The dyed fabric is neutralized at 40° C. in 1000 parts of an aqueous solution which contains 1 part of 50% acetic acid for 10 minutes. It is rinsed again with deionized water at 70° C. and then soaped off at the boil with a laundry detergent for 15 minutes, rinsed once more and dried to provide an orange to red dyeing having very good fastness properties. Similar results are obtained when the process described is repeated with the dye mixtures obtained as per examples 2 and 3.

### EXAMPLE 24

4 parts of a dye mixture obtained as per example 1 and 50 parts of sodium chloride are dissolved in 998 parts of water and 5 parts of sodium carbonate, 2 parts of sodium hydroxide (in the form of a 32.5% aqueous solution) and if appropriate 1 part of wetting agent are added. This dyebath is entered with 100 g of a woven cotton fabric. The rest of the processing is carried out as reported in Example 23 to provide an orange to red dyeing of high color intensity and having very good fastness properties.

Similar results are obtained when the process described is repeated with the dye mixtures obtained as per examples 2 and 3.

### EXAMPLE 25

A textile fabric consisting of mercerized cotton is padded with a liquor containing 35 g/l of anhydrous sodium carbonate, 100 g/l of urea and 150 g/l of a low viscosity sodium alginate solution (6%) and then dried. The wet pickup is 70%.

The thus pretreated textile is printed with an aqueous ink containing

2% of a dye mixture as per example 1
20% of sulfolane

### 0.01% of Mergal K9N

77.99% of water
using a drop-on-demand (bubble jet) inkjet print head. The print is fully dried. It is fixed by means of saturated steam at 102° C. for 8 minutes. The print is then rinsed warm, subjected to a fastness wash with hot water at 95° C., rinsed warm and then dried. The result is a bluish red print having excellent service fastnesses.

### EXAMPLE 26

A textile fabric consisting of mercerized cotton is padded with a liquor containing 35 g/l of anhydrous sodium carbonate, 50 g/l of urea and 150 g/l of a low viscosity sodium alginate solution (6%) and then dried. The wet pickup is 70%. The thus pretreated textile is printed with an aqueous ink containing

8% of a dye mixture as per example 1
20% of 1,2-propanediol

### 0.01% of Mergal K9N and

71.99% of water
using a drop-on-demand (bubble jet) inkjet print head. The print is fully dried. It is fixed by means of saturated steam at 102° C. for 8 minutes. The print is then rinsed warm, subjected to a fastness wash with hot water at 95° C., rinsed warm and then dried. The result is a bluish red print having excellent service fastnesses.

### EXAMPLE 27

A textile fabric consisting of mercerized cotton is padded with a liquor containing 35 g/l of anhydrous sodium carbonate, 100 g/l of urea and 150 g/l of a low viscosity sodium alginate solution (6%) and then dried. The wet pickup is 70%. The thus pretreated textile is printed with an aqueous ink containing

8% of a dye mixture as per example 1

### 15% of N-methylpyrrolidone

### 0.01% of Mergal K9N and

77.99% of water
using a drop-on-demand (bubble jet) inkjet print head. The print is fully dried. It is fixed by means of saturated steam at 102° C. for 8 minutes. The print is then rinsed warm, subjected to a fastness wash with hot water at 95° C., rinsed warm and then dried. The result is a bluish red print having excellent service fastnesses.

1-10. (canceled)

11. A dye mixture containing one or more dyes of the formula (I) 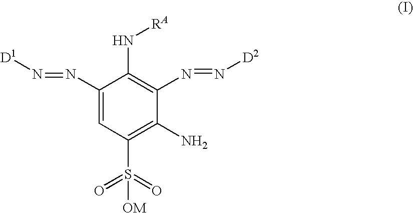
and one or more dyes of the formula (II) 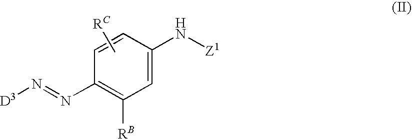
wherein
D¹, D² and D³ independently represent a group of the formula (III) 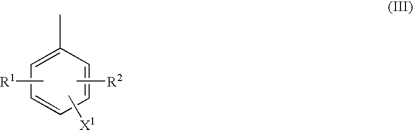
wherein
R¹ and R² are independently hydrogen, (C₁-C₄)-alkyl, (C₁-C₄)-alkoxy, hydroxyl, sulfo, carboxyl, cyano, nitro, amido, ureido or halogen; and
X¹ is hydrogen, sulfo, a group of the formula —SO₂-Z², wherein
Z² is —CH═CH₂ or —CH₂CH₂Z³ and
Z³ is hydroxyl or an alkali-eliminable group;
or wherein
D¹, D² and D³ independently represent is a group of the formula (IV) 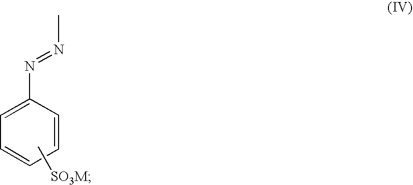
or wherein
D¹, D² and D³ independently represent a group of the formula (V) 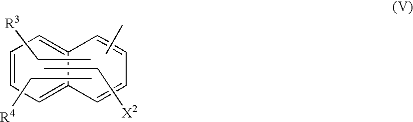
wherein
R³ and R⁴ are independently hydrogen, (C₁-C₄)-alkyl, (C₁-C₄)-alkoxy, hydroxyl, sulfo, carboxyl, cyano, nitro, amido, ureido or halogen; and
X² has one of the meanings of X¹;
or wherein
D¹, D² and D³ independently represent a group of the formula (VI) 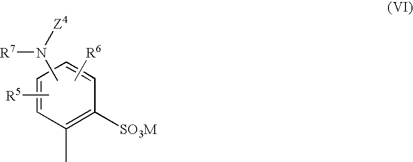
wherein
R⁵ and R⁶ independently have one of the meanings of R¹;
R⁷ is hydrogen, (C₁-C₄)-alkyl, unsubstituted or (C₁-C₄)-alkyl-, (C₁-C₄)-alkoxy-, sulfo-, halogen- or carboxyl-substituted phenyl; and
Z⁴ is a group of the formula (VII), (VIII) or (IX) 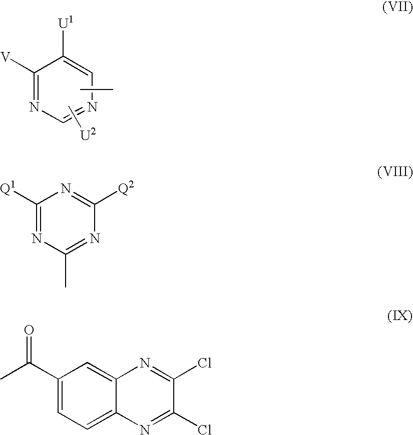
wherein
V is fluorine or chlorine;
U¹ and U² are independently fluorine, chlorine or hydrogen; and
Q¹ and Q² are independently chlorine, fluorine, cyanamido, hydroxyl, (C₁-C₆)-alkoxy, phenoxy, sulfophenoxy, mercapto, (C₁-C₆)-alkylmercapto, pyridino, carboxypyridino, carbamoylpyridino or a group of the formula (X) or (XI) 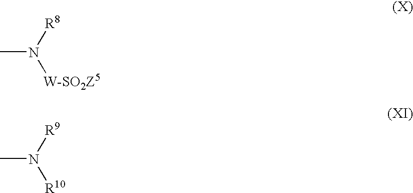
wherein
R⁸ is hydrogen, (C₁-C₆)-alkyl, sulfo-(C₁-C₆)-alkyl, phenyl or (C₁-C₄)-allyl-, (C₁-C₄)-alkoxy-, hydroxyl-, sulfo-, halogen-, carboxyl-, acetamido-, ureido-substituted phenyl;
R⁹ and R¹⁰ independently have one of the meanings of R⁸ or combine to form a group of the formula —(CH₂)ⱼ— or of the formula —(CH₂)₂-E-(CH₂)₂—, where j is 4 or 5, E is oxygen, sulfur, sulfonyl or —NR¹¹ and R¹¹ is (C₁-C₆)-alkyl;
W is phenylene which is unsubstituted or substituted by 1 or 2 substituents selected from the group consisting of (C₁-C₄)-allyl, (C₁-C₄)-alkoxy, carboxyl, sulfo, chlorine and bromine, or is (C₁-C₄)-alkylenephenylene, (C₂-C₆)-alkylene, which is optionally interrupted by oxygen, sulfur, sulfonyl, amino, carbonyl or carboxamido, or is phenylene CONH phenylene which is unsubstituted or substituted by 1 or 2 substituents selected from the group consisting of (C₁-C₄)-allyl, (C₁-C₄)-alkoxy, hydroxyl, sulfo, carboxyl, amido, ureido and halogen, or is naphthylene which is unsubstituted or substituted by one or two sulfo groups; and
Z⁵ has one of the meanings of Z²;
or wherein
D¹, D² and D³ independently represent a group of the general formula (XII) 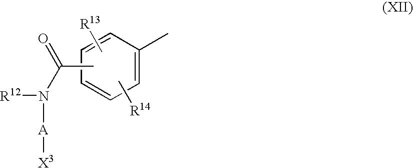
wherein
R¹² is hydrogen, (C₁-C₄)-alkyl, aryl or substituted aryl;
R¹³ and R¹⁴ are independently hydrogen, (C₁-C₄)-allyl, (C₁-C₄)-alkoxy, hydroxyl, sulfo, carboxyl, cyano, nitro, amido, ureido or halogen; and
A is a group of the general formula (XIII) 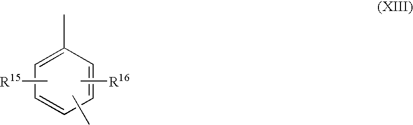
wherein
R¹⁵ and R¹⁶ are independently hydrogen, (C₁-C₄)-alkyl, (C₁-C₄)-alkoxy, hydroxyl, sulfo, carboxyl, cyano, nitro, amido, ureido or halogen; or
A is a group of the formula (XIV) 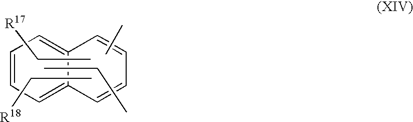
wherein
R¹⁷ and R¹⁸ are independently hydrogen, (C₁-C₄)-alkyl, (C₁-C₄)-alkoxy, hydroxyl, sulfo, carboxyl, cyano, nitro, amido, ureido or halogen; or
or wherein
A is a group of the formula (XV)
—(CR¹⁹R²⁰)ₖ— (XV)
wherein
k is an integer greater than 1;
R¹⁹ and R²⁰ are independently hydrogen, (C₁-C₄)-alkyl, (C₁-C₄)-alkoxy, hydroxyl, cyano, amido, halogen or aryl; and
X³ has one of the meanings of X¹;
R^{A} is hydrogen or a group of the formula (XVII)
—CH₂—SO₃M (XVII);
R^{B} is acetamido, ureido, methyl, methoxy or a group of the formula (XVIII) 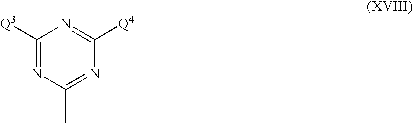
wherein
Q³ and Q⁴ independently have one of the meanings of Q¹;
R^{C} is hydrogen, methyl, methoxy or sulfo;
Z¹ has one of the meanings of Z⁴; and
M is hydrogen, an alkali metal or one equivalent of an alkaline earth metal;
wherein the dyes of the general formulae (I) and (II) contain at least one fiber-reactive group of the formula —SO₂Z² or Z⁴, of the formula (XVIII) or Z¹ and
wherein compounds of the formula (A) 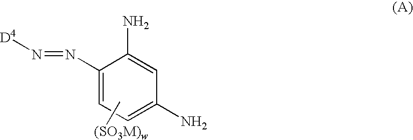
where in
D⁴ is a group of the formula (B) or (C) 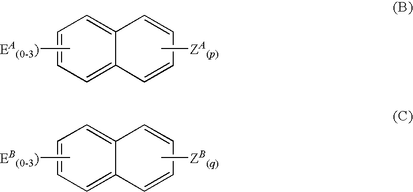
wherein
E^{A}₍₀₋₃₎ and E^{B}₍₀₋₃₎ are the same or different, 0 to 3 groups selected from hydrogen, —SO₃M, —OH, —COOM, —F, —Cl, —Br, (C₁-C₄)-alkyl oder (C₁-C₄)-alkoxy;
p and q are a number of 0 to 2;
Z^{A} and Z^{B} are a group of formula (Da), (Db), (Dc) or (Dd),
—SO₂—Y^{A} (Da)
—CONH—(CH₂)ᵣ—SO₂—Y^{A} (Db)
—NHCONH(Hal)CH₂Hal (Dc)
—NHCOCH(Hal)=CH₂ (Dd)
r is a number of 0 to 5;
Hal is halogen;
Y^{A} is vinyl, β-chloroethyl, β-bromoethyl, β-acetylethyl, β-sulfatoethyl, β-phen-oxyethyl, β-phosphatoethyl or a —CH₂—CH₂-U group;
U is a leaving group which can be cleaved under alkaline conditions; and
M is defined as given above;
are contained in an amount of maximum 1% by weight, based on the total amount of dyestuff.

12. The dye mixture as claimed in claim 11, wherein
R¹ and R² are independently hydrogen, methyl, methoxy or sulfo;
R³ to R⁶ are independently hydrogen or sulfo;
R⁷ and R⁸ are independently hydrogen or phenyl;
R⁹ and R¹⁰ are independently hydrogen, 2-sulfoethyl, 2-, 3- or 4-sulfophenyl or combine to form —(CH₂)₂—O—(CH₂)₂—;
R¹¹ is hydrogen or methyl;
R¹² to R¹⁶, R¹⁹, R²⁰, R^{A} and R^{C} are hydrogen;
R¹⁷ and R¹⁸ are independently hydrogen or sulfo;
R^{B} is acetamido or ureido; and
Z² and Z⁵ are independently vinyl, β-chloroethyl or β-sulfatoethyl.

13. The dye mixture as claimed in claim 11, wherein D¹ and D² represent a group of the formula (III) or (VI).

14. The dye mixture as claimed in claim 11, wherein D³ represents a group of the formula (V) where R³, R⁴ and X² are hydrogen or sulfo.

15. The dye mixture as claimed in claim 11, wherein Z¹ is a group of the formula (VIII) where Q¹ is fluorine or chlorine and Q² is cyanamido, morpholino, 2-sulfophenylamino, 3-sulfophenylamino, 4-sulfophenylamino, 3-(2-sulfatoethylsulfonyl)phenylamino, 4-(2-sulfatoethylsulfonyl)phenylamino, 3-(vinylsulfonyl)phenylamino, 4-(vinylsulfonyl)phenylamino), N-methyl-N-(2-(2-sulfatoethylsulfonyl)ethyl)amino, N-phenyl-N-(2-(2-sulfatoethylsulfonyl)ethyl)amino or 2-[2-(2-chloroethylsulfonyl)ethoxy]ethylamino.

16. The dye mixture as claimed in claim 12, wherein D¹ and D² represent a group of the formula (III) or (VI).

17. The dye mixture as claimed in claim 16, wherein D³ represents a group of the formula (V) where R³, R⁴ and X² are hydrogen or sulfo.

18. The dye mixture as claimed in claim 17, wherein Z¹ is a group of the formula (VIII) where Q¹ is fluorine or chlorine and Q² is cyanamido, morpholino, 2-sulfophenylamino, 3-sulfophenylamino, 4-sulfophenylamino, 3-(2-sulfatoethylsulfonyl)phenylamino, 4-(2-sulfatoethylsulfonyl)phenylamino, 3-(vinylsulfonyl)phenylamino, 4-(vinylsulfonyl)phenylamino), N-methyl-N-(2-(2-sulfatoethylsulfonyl)ethyl)amino, N-phenyl-N-(2-(2-sulfatoethylsulfonyl)ethyl)amino or 2-[2-(2-chloroethylsulfonyl)ethoxy]ethylamino.

19. The dye mixture as claimed in claim 11, containing one or more dyes of the formula (Ia) 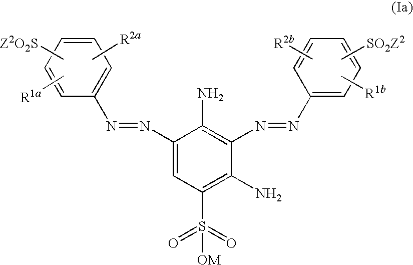
and one or more dyes of the formula (IIa) 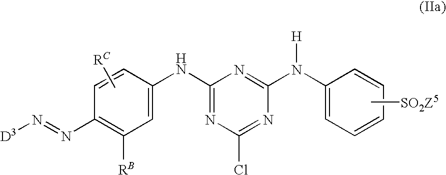
wherein
R^{1a}, R^{1b}, R^{2a} and R^{2b} are independently hydrogen, methyl, methoxy or sulfo;
Z² and Z₅ are independently vinyl or β-sulfatoethyl;
and D³, R^{B}, R^{C} and M are each as defined in claim 11.

20. The dye mixture as claimed in claim 11, containing the dye or dyes of the formula (I) in an amount of 1% to 99% by weight and the dye or dyes of the formula (II) in an amount of 1% to 99% by weight all based on total dye.

21. The dye mixture as claimed in claim 11, containing the dye or dyes of the formula (I) in an amount of 10% to 90% by weight and the dye or dyes of the formula (II) in an amount of 10% to 90% by weight, all based on total dye.

22. A process for preparing a dye mixture as claimed in claim 11, which comprises the individual dyes being mechanically mixed with each or one another.

23. A process for dyeing or printing carboxamido- and/or hydroxyl-containing material which comprises contacting the material with the dye mixture as claimed claim 11.

24. An ink for digital textile printing by the inkjet process, containing a dye mixture as claimed in claim 11.
